(19) United States
(12) Patent Application Publication
(10) Pub. No.: US 2012/0258280 A1
(43) Pub. Date: Oct. 11, 2012

(54) EXTENDED LIFE TEXTURED CHAMBER COMPONENTS AND METHOD FOR FABRICATING SAME

(75) Inventors: Michael Jackson, Sunnyvale, CA (US); Wendell G. Boyd, JR., Morgan Hill, CA (US); Tiong Khai Soo, San Jose, CA (US); William Ming-Ye Lu, Sunnyvale, CA (US); Goichi Yoshidome, Emeryville, CA (US); Joseph F. Sommers, San Jose, CA (US)

(73) Assignee: APPLIED MATERIALS, INC., Santa Clara, CA (US)

(21) Appl. No.: 13/442,816

(22) Filed: Apr. 9, 2012

Related U.S. Application Data
(60) Provisional application No. 61/474,268, filed on Apr. 11, 2011.

(51) Int. Cl. B32B 3/30; C23F 1/00

(52) U.S. Cl. 428/141; 216/41; 428/156

(57) ABSTRACT

A processing chamber component and method for fabricating the same are provided. The processing chamber component is fabricated in the manner described herein and includes the creation of at least a macro texture on a surface of the chamber component. The macro texture is defined by a plurality of engineered features arranged in a predefined orientation on the surface of the chamber component. In some embodiments, the engineered features prevent formation of a line of sight surface defined between the features to enhance retention of films deposited on the chamber component.

### CROSS REFERENCE TO RELATED APPLICATION

This application claims benefit of U.S. Provisional Patent Application No. 61/474,268 filed Apr. 11, 2011, which is incorporated by reference in its entirety.

### BACKGROUND OF THE INVENTION

1. Field of the Invention

Embodiments of the present invention generally relate to processing chamber components and method for fabricating same.

2. Description of the Related Art

Processing chamber components have been roughened to enhance the retention of deposited films, thereby extending the time at which the chamber component must be cleaned to preventing the films from flaking off the chamber component and becoming sources of contamination. However, as surfaces have been roughened to greater and greater surface roughness (R_{A}) with the intention of retaining films for even longer intervals, the peaks of the roughened surfaces have an increasing propensity to break off, thus becoming a source of contamination themselves and making many highly roughened surfaces unsuitable for critical applications.

Thus, there is a need for an improved processing chamber component.

### SUMMARY OF THE INVENTION

A processing chamber component and method for fabricating the same are provided. The processing chamber component is fabricated in the manner described herein and includes the creation of at least a macro texture on a surface of the chamber component. The macro texture is defined by a plurality of engineered features arranged in a predefined orientation on the surface of the chamber component. In some embodiments, the engineered features prevent formation of a line of sight surface defined between the features to enhance retention of films deposited on the chamber component.

In one embodiment, a chamber component includes a surface having macro textured features and micro textured surface roughness. In another embodiment, a method for fabricating a chamber component includes disposing a resist mask on a surface of a semiconductor chamber component and removing material from the semiconductor chamber component through an opening formed in the resist mask to form a transferred pattern of discrete features. In another embodiment, a chamber component includes a surface having macro textured features and micro textured surface roughness wherein the features have rounded edges.

In another embodiment, an article having a surface patterned to enhance retention of deposited films is provided that includes a processing chamber component having a macro textured surface formed from engineered features arranged to prevent formation of a line of sight surface across textured surface.

In another embodiment, an article having a surface patterned to enhance retention of deposited films is provided that includes a processing chamber component having a macro textured surface formed from engineered features arranged in a predefined pattern that prevents formation of a line of sight surface across textured surface, the engineered features are arranged in a predefined pattern, the engineered features forming the textured surface micro textured to a surface finish of about 100 to about 300 R_{A}.

In yet another embodiment, a method for fabricating a semiconductor chamber component is provided that includes covering a surface of a chamber component with a mask, and removing material from the surface of a chamber component to form a plurality of engineered features defining a textured surface, the engineered features arranged to prevent formation of a line of sight surface across textured surface.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is partial plan view of a textured surface of a processing chamber component of one embodiment of the invention.

FIG. 2 is partial sectional view of the textured surface of the processing chamber component of FIG. 1.

FIG. 3 is partial sectional view of the textured surface of the processing chamber component of FIG. 2 having a resist mask disposed thereon.

FIG. 4 is a partial plan view of one embodiment of a resist mask.

FIG. 5 is partial sectional view of another embodiment of a textured surface of a processing chamber component.

FIG. 6 is partial sectional view of the textured surface of the processing chamber component of FIG. 5 having a resist mask disposed thereon.

FIGS. 7-8 are exemplary embodiments of processing chamber components having one or more textured surfaces.

FIG. 9 is a top plan view of a textured surface of a processing chamber component of another embodiment of the invention.

FIG. 10 is a cross-sectional view of the textured surface of the processing chamber component of FIG. 9 taken through section line A-A.

FIG. 11 is a partial plan view a textured surface of a processing chamber component of one embodiment of the invention.

FIG. 12 is a partial cross-sectional view of the textured surface of the processing chamber component of FIG. 11 taken through section line B-B.

FIGS. 13A-13E are partial cross-sectional views of a processing chamber component illustrating different stages of a fabrication sequence utilized to form one embodiment of a textured surface on the processing chamber component.

To facilitate understanding, identical reference numerals have been used, where possible, to designate identical elements that are common to the figures. It is also contemplated that elements and features of one embodiment may be beneficially incorporated on other embodiments without further recitation.

### DETAILED DESCRIPTION

Embodiments of the invention relate to methods to extend the kit life in a processing chamber and processing chamber components fabricated by the same. The processing chamber components fabricated in the manner described herein include the creation of at least a macro texture on a surface of the chamber component which has enhanced film retention, thereby extending the surface interval and additionally reducing particle contamination. Thus, the novel processing chamber components contribute to reduced tool downtime and lower cost of ownership. It is contemplated that a “processing chamber component” includes components utilized in processing chambers used for the fabrication of integrated circuits, flat panel displays, solar panels, OLED's, LED's, and the like. It is also contemplated that the texturizing techniques described herein may find utility in other applications in which retention of a film to a surface is desired.

Embodiments of the invention involve the deliberate creation of a macro texture on a process kit surface (e.g., surface of a chamber component) using a lithographic methodology in optional conjunction with micro-texture bead-blasting. The macro texture may be designed using knowledge of the film properties to maximize the percentage of the film retained. In the example of a compressive metal film, a recessed texture may be used to retain the film even in the event that the film fractures. This methodology allows the creation of a pattern on a process kit part that is tuned for the properties of the specific film, as well as pattern parts which cannot take the thermal load of alternative thermal patterning techniques. The method for texturizing the processing chamber component also avoids the challenges associated with making high-roughness coatings production-worthy. In some instances, defect counts have been substantially reduced, as well as substantially extending kit life. This process can potentially be used on all defect-sensitive parts of a process chamber. It is particularly useful on processes that do not have in-situ clean capabilities (e.g. PVD chambers and some metal CVD chambers).

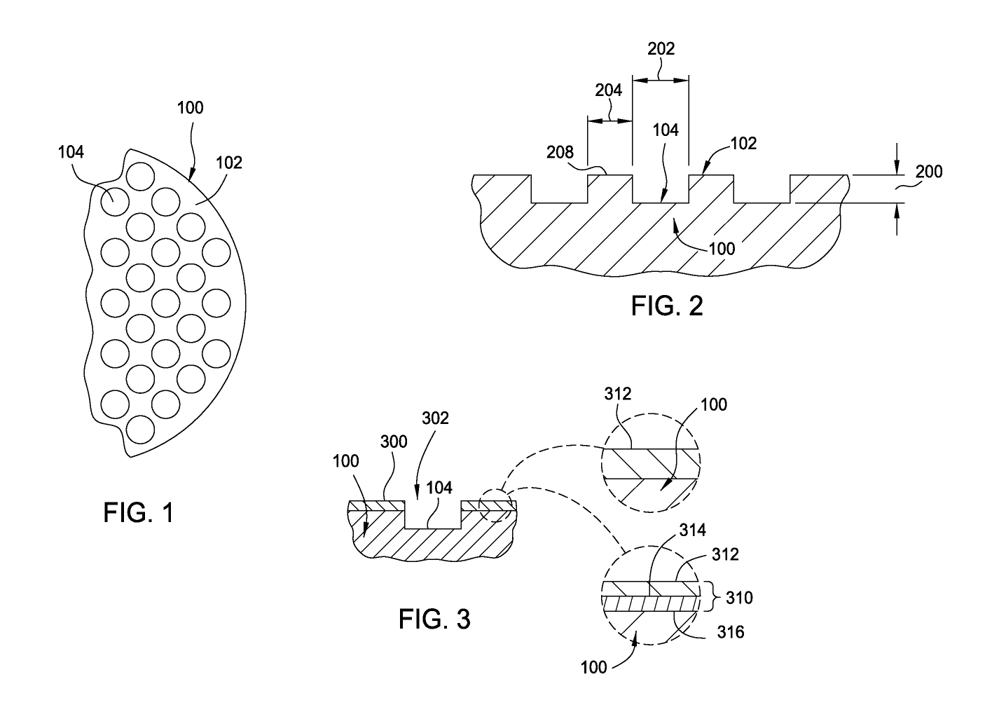

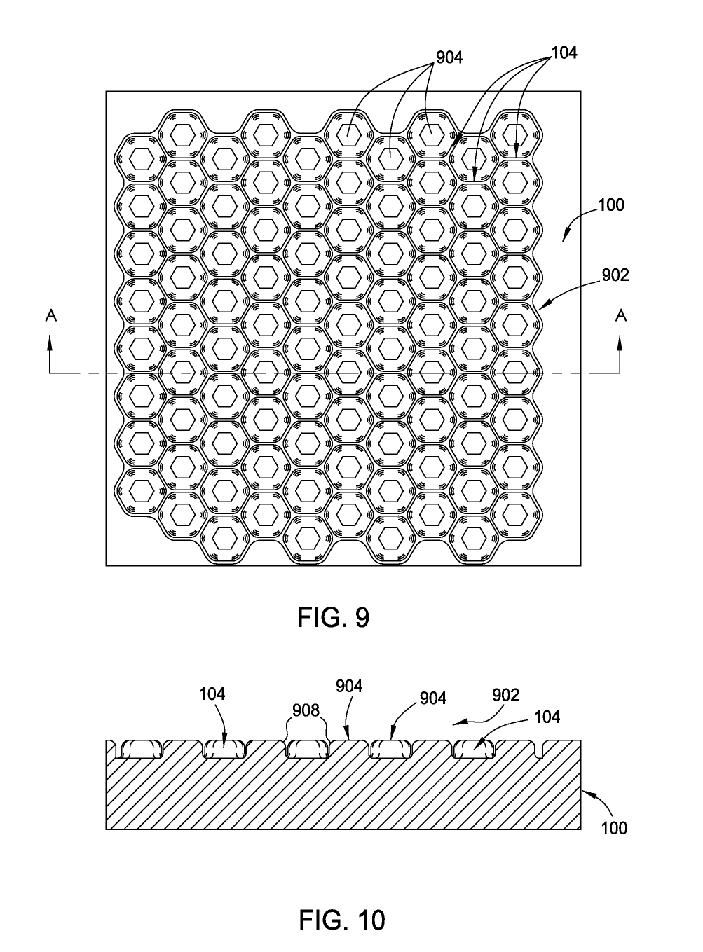

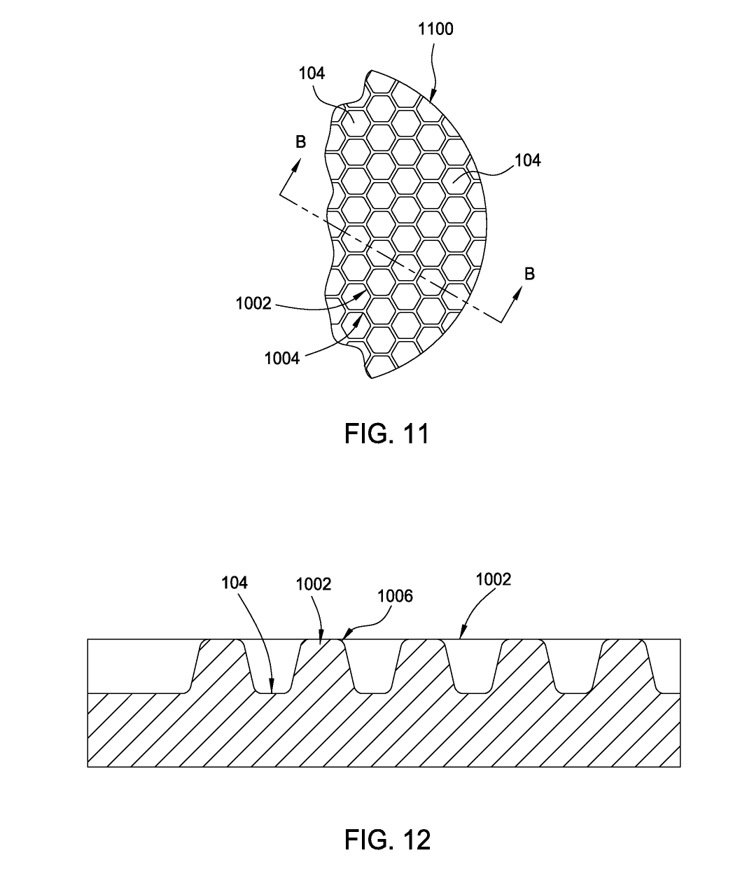

FIG. 1 is partial plan view of a macro textured surface 102 of a processing chamber component 100 of one embodiment of the invention. The macro textured surface 102 includes a repetitive predefined pattern of engineered features 104. The term “engineered features” means that the general shape and arrangement of the features are transferred to the surface of the chamber component utilizing a mask or other precision machining technique that predefines where material is removed from the surface of the chamber component such that a predefined pattern of apertures is formed, for example, but utilizing the shape and arrangement of apertures formed through the mask to define the arrangement of features 104. For example, surface etching or bead blasting without the use of a mask cannot form an engineered feature. The engineered features 104 are at least partially recessed below the pre-textured surface of the chamber component 100, e.g., the top of the features 104 may be substantially coplanar with the pre-textured surface of the chamber component 100. The features 104 may be contiguously connected, or be discrete forms. For example, the features 104 may be contiguously connected recesses formed by removing material from the pre-textured surface of the chamber component 100 to leave a “pillars” of material, as shown in the exemplary embodiments depicted in FIGS. 2 and 11; the features 104 may be discrete recesses in the form of a plurality of interconnected walls or ridges separating recessed areas formed in the pre-textured surface of the chamber component 100, as shown in the exemplary embodiments depicted in FIGS. 5 and 9; or a combination of contiguously connected and discrete features. The features 104 formed in the surface 102 may be arranged in a repetitive pattern or in a random manner. In one embodiment the features 104 are arranged to avoid creation of an uninterrupted planar surface between the features 104, for example, by arranging the features 104 in pattern or other arrangement that prevents a line of sight surface from being formed between the features 104 across the textured surface 102. Examples of features 104 arranged in pattern that has no line of sight surface defined between the features 104 across the textured surface 102 is depicted and described below with reference to FIGS. 9 and 11. Beneficially, a processing chamber component 100 having a textured surface 102 with no line of sight surfaces defined between the features 104 forming the textured surface 102 eliminates long uninterrupted linear surfaces which are susceptible to peeling of deposited material and/or easily shed particles. Thus, processing chamber component 100 having a textured surface 102 with no line of sight surfaces defined between the features 104 allow for longer service intervals between cleaning with diminished risk of deposited film flaking, thereby improving product yields, reduced maintenance requirements and more profitable operation of processing chambers in which the texturized processing chamber component 100 is utilized.

The ease in which engineered features 104 may be applied to the processing chamber component 100 allow a macro textured surface 102 to be formed surfaces where traditional texturing either would not be possible or could potentially damage the chamber component. For example, the engineered features 104 and macro textured surface 102 can be formed on processing chamber components 100 fabricated from stainless steel, aluminum, ceramic or other patternable materials.

As discussed above, the features 104 may have any number of geometric shapes, and the shapes do not have to be uniform across the textured surface 102. Although the features 104 are shown in plan view as circles (i.e., cylinders), the features 104 may have a groove, a polygonal or irregular shape, among others. Alternatively, the spacing between the features 104 may have a uniform or irregular shape, size and distribution across the textured surface 102.

FIG. 2 is partial sectional view of the textured surface 102 of the processing chamber component 100 of FIG. 1. The features 104 are illustrated as formed into the textured surface 102 to a depth 200, having a width or mean diameter 202 and an average spacing 204. The features 104 are considered a macro texture, as the textured surface 102 is micro textured after feature formation, as further discussed below. The depth 200 may be in the range of 100 um to about 200 um, and may even be as much as about 1 mm deep. The width or mean diameter 202 may be about 100 um to about 200 um, and may even be as much as about 1 mil wide. In some embodiments, a ratio of mean diameter 202 to depth 200 may range from about 1.0:0.5 to about 0.5:1.0. In one embodiment, the average spacing 204 between features 104 may be at least about 0.5 mm to allow sufficient surface area (e.g., a web 208 remaining on the textured surface 102 defined between edges of adjacent features 104) for good adhesion of a resist mask discussed below utilized to form the features 104.

FIG. 3 is partial sectional view of the textured surface 104 of the processing chamber component 100 of FIG. 2 illustrating one embodiment of a resist mask 300 disposed on the web 208 of the textured surface 104. The resist mask 300 is patterned to form openings 302 through which the features 104 are mechanically and/or chemically formed in the component 100. In one embodiment, the shape of the openings is transferred to the features 104 by bead blasting the processing chamber component 100 through the openings 302 of the resist mask 300. In another embodiment, the shape of the openings is transferred to the features 104 by wet or dry etching the processing chamber component 100 through the openings 302 of the resist mask 300. In this manner, a transferred pattern of discrete features 104 are formed in a predefined pattern. The resist mask 300 may be applied on the processing chamber component 100 as a layer of liquid or gel material which is later patterned; or as a sheet of preformed resist.

The resist mask 300 may be patterned using lithography or other suitable technique to form openings 302. In one embodiment, a layer of resist material is patterned on the surface 102 prior to texturing such that portions of the resist material become brittle. When the layer of resist material is bead blasted, the brittle portions of the layer of resist material fracture and break away to define the openings 302 through which the features 104 are mechanically formed by continued bead blasting of the now exposed surface 102. The portions of the layer of resist material remaining on the surface during bead blasting prevent removal of material from the processing chamber component 100, thereby forming the web 208. In another embodiment, the portions of the layer of resist material which are undeveloped may be removed by a suitable technique, such as power washing, to form the openings 302 in the resist mask 300.

In another embodiment, the layer of resist material utilized as the resist mask 300 is in the form of a sheet of resist which may be patterned before or after application to the surface 102 of the processing chamber component 100. For example, a sheet of resist 310 may include a resist layer 312 disposed on a backing 314. The sheet of resist 310 may include a pressure sensitive adhesive 316 for securing the sheet of resist 310 to the processing chamber component 100. The sheet of resist 310 may be patterned prior to or after coupling to the processing chamber component 100. In one embodiment, an art pattern is applied to the sheet of resist 300 which is a photoresist, and UV light is exposed to the resist 300 through the art pattern. A chemical etching process is performed to remove the surface 102 not protected by the resist 300 to form features 104, and the remaining resist 300 may be stripped, washed, dry etched away or the like. This process advantageously allows the resist 300 to adhere to the surface 102 to form uniform features 104.

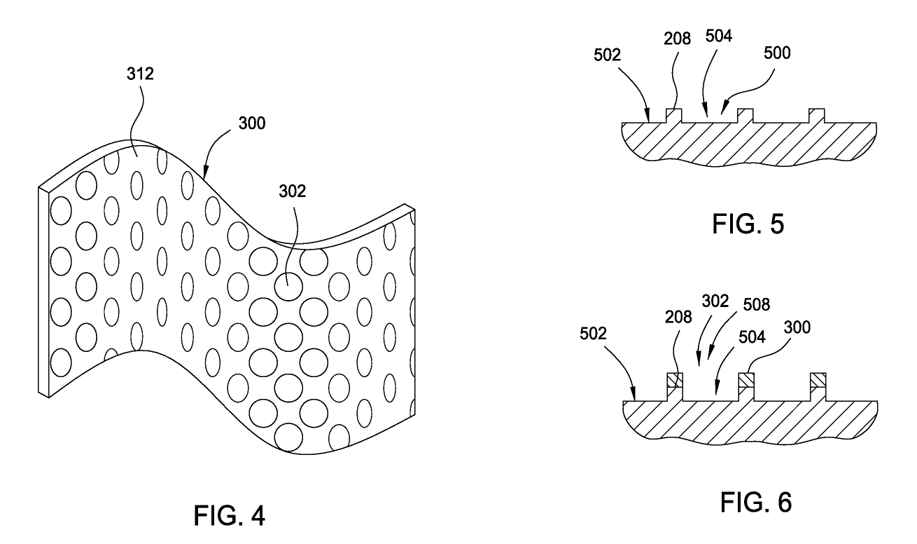

In yet another embodiment, the resist layer 312 (as additionally seen in FIG. 4 without the backing 314 with the openings 302 formed therein prior to attachment to component 100) is separated from the other portions of the sheet of resist 310 prior to coupling to the processing chamber component 100. Since the separated resist layer 312 is highly flexible, the resist layer 312 may be more conformally applied to surfaces of the processing chamber component 100 having complex or highly contoured surface more easily than the entire sheet of resist 310, thereby preventing wrinkling of the mask layer 300 and allowing shape of the features 104 to be more precisely formed through the openings 302. The open openings 302 in the resist layer 312 without the backing 314 may be patterned prior to or after coupling to the processing chamber component 100.

FIGS. 5 and 6 are partial sectional views of another embodiment of a macro textured surface 502 of a processing chamber component 500. Features 504 are formed in the processing chamber component 500 substantially as described above, except that the web 208 formed below a resist mask 300 between adjacent features 504 is substantially smaller than the feature 504, such that the predominant structures present on the textured surface 502 are the raised web 208, as opposed to the recessed features 504, such as shown in FIG. 2.

The macro textured surfaces 102, 502 may be optionally micro textured prior to the application or after the removal of the resist mask 300. Micro texturing is applied to the surface contour of the features 104, 504, and may be formed mechanically by bead blasting both the feature 104, 504 and the web 208 of the chamber components 100, 500. In one embodiment, textured surfaces 102, 502 described herein, may be bead blasted to a surface finish of about 100 to about 300 R_{A}. Micro texturing may optionally be accomplished through non-mechanical methods, such as acid etching, plasma treatment or other suitable procedure that may produces a suitable surface finish.

FIG. 9 is partial sectional view of another embodiment of a macro textured surface 902 of a processing chamber component 900. Engineered features 104 forming the macro textured surface 902 are formed in surface of the processing chamber component 900 substantially as described above, except that structures 904 defined between the features 104 have a rounded edge 908, as better seen in FIG. 10. The structures 904 may be in the form of pillars of material bounded by the features 104 formed by the material removed during the creation of the textured surface. The pillars extend from the processing chamber component 900 and may have any suitable geometric profile, such as cylindrical, polygonal, oval, or other suitable shape. The pillars extending from the processing chamber component 900 may be uniform in shape, size and distribution, or may vary in one or more of shape, size and distribution across the textured surface. The pillars may be discreet and unconnected to neighboring pillars, or two or more pillars may be connected by a web of material.

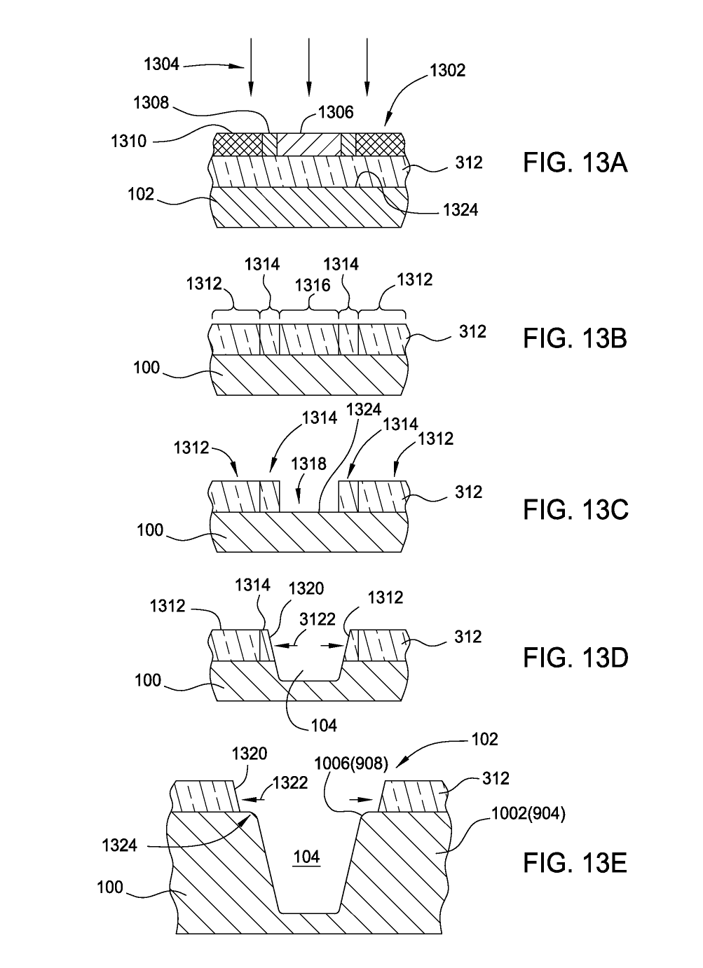

In one embodiment, the rounded edges 908 may be formed advantageously during the chemical etching or bead blasting process described above, as described below with reference to FIGS. 13A-13E, or other suitable process, without the need for subsequent bead blasting. Because certain materials and thin chamber components cannot withstand the heat and stress of bead blasting, chemical etching allows the features 104 and rounded edges 908 of the structures 904, but not limited to, chamber components having a thickness of less than 0.1 inches. In the embodiment depicted in FIGS. 9 and 10, the structures 904 defined by the features 104 are arranged in close-packed hexagonal pattern, such that a line of sight surface between the features is not present to enhance film retention characteristics of the textured surface 902. For example, as illustrated in FIG. 10, the structures 904 formed one staggered behind the other block the line of sight across the macro textured surface 902, thereby enhancing film adhesion.

FIG. 11 is a partial plan view a macro textured surface 1100 of a processing chamber component 100 according to another embodiment of the invention. Engineered features 104 are formed in the surface of the chamber component 100 and separated by interconnecting walls 1002 such that no line of sight surface is defined on the wall across the textured surface 1100. In one embodiment, the interconnecting walls 1002 formed a plurality of cylindrical, oval or polygonal shapes, for examples, the walls 1002 may be arranged to define a honeycomb pattern. The intersection 1004 of the walls 1002 may be rounded to reduce stresses on both the textured surface 1100 and films deposited thereon. Additionally, outer edges 1006 of the walls 1002 defined by the features 104 may be advantageously rounded during formation of the engineered features 104. In the chemical etching process, as described above, the photoresist is not completely developed at the edges of the art pattern, so that the photoresist erodes away during the chemical or mechanical formation of the features 104 to create rounded edges 1006 as seen in FIG. 12 so that subsequent blasting is not required for edge rounding.

The engineered features 104 formed in the surface of the chamber component 100 and separated by interconnecting walls 1002 and may have any suitable geometric profile, such as cylindrical, polygonal, oval, or other suitable shape. The engineered features 104 formed in the processing chamber component 100 may be uniform in shape, size and distribution, or may vary in one or more of shape, size and distribution across the macro textured surface 1100.

FIGS. 13A-13E are partial cross-sectional views of a processing chamber component 100 illustrating different stages of a fabrication sequence utilized to form one embodiment of a textured surface 102 on the processing chamber component 100 using engineered features 104. Advantageously, the process illustrated in FIGS. 13A-13E allows for the structures defined by the engineered features 104 to be formed with rounded outer edges 1006, thereby forming a more stress free textured surface 102 that more readily retains deposited films.

Referring first to FIG. 13A, the processing chamber component 100 is coated with a photoresist layer 314. Artwork 1302 is disposed over or place on top of the photoresist layer 314. The artwork 1302 includes at least three types of regions: a plurality of transparent regions 1306 through which energy 1304 passes to exposed the underlying photoresist layer 314; opaque regions 1308 immediately bounding the transparent regions 1306; and non-transparent regions 1310 which substantially block energy 1304 from exposing the underlying photoresist layer 314. The opaque regions 1308 have a grayscale selected to allow a portion of the energy 1304 to partially expose the underlying photoresist layer 314. Thus, the underlying photoresist layer 314 is exposed through the artwork 1302 to form a developed region 1312, a partially developed region 1314, and a non-developed region 1316, as shown in FIG. 13B.

The non-developed region 1316 is removed, for example by bead blasting, etch or power washing to form an opening 1318 exposing an upper surface 1324 of the chamber component 100 through the patterned photoresist layer 314, as illustrated in FIG. 13C.

Referring now to FIGS. 13D-13E, an engineered feature 104 is formed by removing material from the upper surface 1324 of the processing chamber component 102. As discussed above, the material may be removed by bead blasting, etch or power washing. The partially developed region 1314, being softer or more brittle (depending on the photoresist utilized), is quickly eroded during the material removal process, thus increasing the aperture (width or diameter 1322) of the opening 1318 while the engineered feature 104 is formed. Near the completion of the material removal process, the partially developed region 1314 is eroded to the point that the underlying upper surface 1324 of the processing chamber component 102 becomes exposed such that the outer edges 1006 of the walls 1002 bounding the feature 104 become rounded. The rounded outer edges 1006 advantageously reduces the stress stresses on both the textured surface 1100 and films deposited thereon.

It is noted that in any of the embodiments described above, the engineered features forming the textured surface 102, 502, 902, 1100 may optionally be micro textured a surface finish of about 100 to about 300 R_{A}. Micro texturing may applied by bead blasting acid etching, plasma treatment or other suitable procedure that may produces a suitable surface finish.

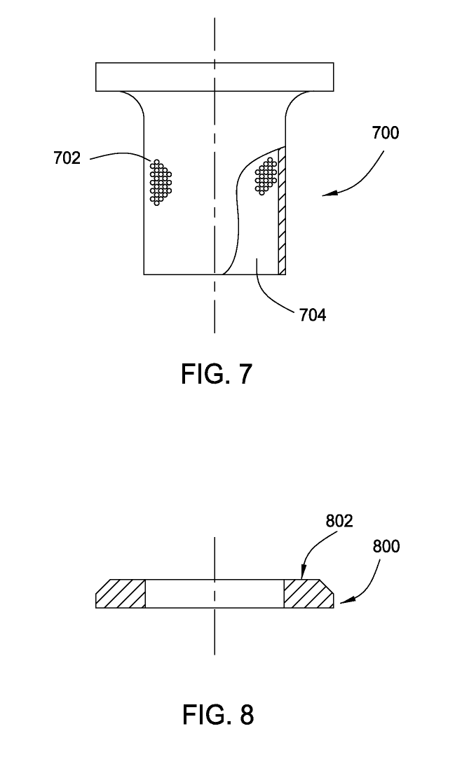

FIGS. 7 and 8 are exemplary embodiments of processing chamber components having one or more textured surfaces. A PVD chamber shield 700 is illustrated in FIG. 7. The shield 700 includes at least one surface textured as described above. For example, at least one of an outer diameter surface 702 or an inner diameter surface 704 (shown in cut-away) of the shield 700 is macro textured to form engineered features as discussed above, and the engineered features may be optionally micro textured. A process kit ring 800 is illustrated in FIG. 8. The ring 800 includes at least one macro textured surface formed using engineered features as described in the embodiments above, wherein the engineered features may be optionally micro textured. For example, at least an upper disk shaped surface 802 of the ring 800 may be both macro and micro textured. The ring 800 may be a deposition ring, a clamp ring, a cover ring, a focus ring, an edge ring or other ring utilized in a semiconductor processing chamber. The semiconductor chamber components discussed above with reference to FIGS. 7 and 8 are by way of illustration, and other semiconductor chamber components, such as but not limited to chamber bodies, pedestals, liners, collimators, shadow frames, and cover rings among others, may be macro and micro textured for form a textured semiconductor chamber component having extended service life and low particle generation characteristics. While the foregoing is directed to embodiments of the present invention, other and further embodiments of the invention may be devised without departing from the basic scope thereof, and the scope thereof is determined by the claims that follow.

1. An article having a surface patterned to enhance retention of deposited films, comprising:
a processing chamber component having a macro textured surface formed from engineered features arranged to prevent formation of a line of sight surface across textured surface.

2. The article of claim 1, wherein the engineered features are arranged in a predefined pattern.

3. The article of claim 1, wherein the engineered features have a depth of between about 100 um to about 200 um.

4. The article of claim 3, wherein the engineered features have a width of between about 100 um to about 200 um.

5. The article of claim 4, wherein the engineered features have a ratio of average width to depth between about 1.0:0.5 to about 0.5:1.0.

6. The article of claim 1, wherein the engineered features are bounded by walls forming a honeycomb pattern.

7. The article of claim 1, wherein the engineered features are closely packed.

8. The article of claim 1, wherein the engineered features form discreet pillars.

9. The article of claim 8, wherein the pillars are arranged to arranged to prevent formation of a line of sight surface across textured surface.

10. The article of claim 1, wherein engineered features forming the textured surface are micro textured to a surface finish of about 100 to about 300 R_{A}.

11. The article of claim 10, wherein engineered features forming the textured surface are micro textured to a surface finish of about 100 to about 300 R_{A}.

12. The article of claim 1, wherein the engineered features forming the textured surface have at least one of a uniform shape, size and distribution across the textured surface.

13. An article having a surface patterned to enhance retention of deposited films, comprising:
a processing chamber component having a macro textured surface formed from engineered features arranged in a predefined pattern that prevents formation of a line of sight surface across textured surface, the engineered features are arranged in a predefined pattern, the engineered features forming the textured surface micro textured to a surface finish of about 100 to about 300 R_{A}.

14. The article of claim 13, wherein the engineered features are bounded by walls forming a honeycomb pattern.

15. The article of claim 13, wherein the engineered features are closely packed.

16. The article of claim 13, wherein the engineered features form discreet pillars.

17. The article of claim 16, wherein the pillars are arranged to arranged to prevent formation of a line of sight surface across textured surface.

18. A method for fabricating a semiconductor chamber component, comprising:
covering a surface of a chamber component with a mask; and
removing material from the surface of a chamber component to form a plurality of engineered features defining a textured surface, the engineered features arranged to prevent formation of a line of sight surface across textured surface.

19. The method of claim 18, wherein the mask further comprises:
a developed region, a partially developed region, and a non-developed region.

20. The method of claim 19, wherein removing material from the surface of the chamber component comprises:
eroding the partially developed region to exposed the surface of the chamber component adjacent the engineered feature being formed; and
creating rounded edges of a structure bounding the engineered feature.
